(19) United States
(12) Patent Application Publication
(10) Pub. No.: US 2007/0050445 A1
(43) Pub. Date: Mar. 1, 2007

(54) Internet content analysis

(76) Inventor: Hugh Hyndman, Mississauga (CA)

Correspondence Address: SMART AND BIGGAR, 438 UNIVERSITY AVENUE, SUITE 1500 BOX 111, TORONTO, ON, M5G2K8, CA

(21) Appl. No.: 11/215,119

(22) Filed: Aug. 31, 2005

(51) Int. Cl. G06F 15/16

(52) U.S. Cl. 709/203

(57) ABSTRACT

Categorisation selections are received at a client computer. Internet content (e.g., a web page) is received by the client from a server and displayed. A categorisation selection is received from the set of categorisation selections through a user interface of the client and this selection is sent to the server. At a server side, web content may be filtered (e.g., searched for keywords) and, based on the filtering, an item of web content may be added to a database. The given item may be sent to a client and an indication of a categorisation for the given item of web content may be returned. The categorisation may be logged and the given item of web content marked as categorized.

### BACKGROUND

This invention relates to the categorisation of content available on an internet.

Attempts have been made at categorizing information available on the Internet and, especially, content available on the World Wide Web. For example, U.S. Pat. No. 6,266,664 to Russell-Falla discloses developing a set of keywords, with weightings associated with each keyword, based on the ability of each keyword to indicate the likelihood that a web page has certain content. A web page may then be searched for keywords that are in the set. The weightings associated with the keywords which are found in the web page are summed and if the sum exceeds a threshold, the web page is considered to have the content indicated by the set of keywords. This approach may be used to implement surf control, that is, the approach may be used to block web pages requested by a user that are considered to have inappropriate content.

Keyword searching has also been used to categorize information available on the Internet for the purposes of providing market intelligence. For example, a corporation may be interested to learn how well a new product is being received in the marketplace. Commentary on the Internet is one manner of obtaining such feedback. Thus, a set of keywords may be developed to identify the product and to identify positive (or negative) feedback.

It would be advantageous to have an improved approach to providing market intelligence from information on the Internet.

### SUMMARY OF INVENTION

Categorisation selections are received at a client computer. Internet content (e.g., a web page) is received by the client from a server and displayed. A categorisation selection is received from the set of categorisation selections through a user interface of the client and this selection is sent to the server.

At a server side, web content may be filtered (e.g., searched for keywords) and, based on the filtering, an item of web content may be added to a database. The given item may be sent to a client and an indication of a categorisation for the given item of web content may be returned. The categorisation may be logged and the given item of web content marked as categorized.

Accordingly, the present invention provides a computer readable medium containing computer readable instructions which, when executed by a client computer, adapt said client computer to: obtain a set of categorisation selections; receive internet content from a server; display said internet content on a display of said client; receive from a user interface a categorisation selection from said set of categorisation selections; and send said categorisation selection to said server. A related method is also provided.

In accordance with another embodiment, the present invention provides, at a server, a method of categorizing web content, comprising: filtering web content; responsive to said filtering, adding a given item of web content to a database; sending said given item of web content to a client; receiving from said client an indication of a categorisation for said given item of web content; logging said categorisation; marking said given item of web content as categorized.

Other features and advantages of the invention will be apparent from the following description in conjunction with the drawings.

### BRIEF DESCRIPTION OF THE DRAWINGS

In the figures which illustrate an example embodiment of the invention,

FIG. 1 is a schematic view of a system adapted for use with the subject invention,

FIG. 2 is a partial functional block diagram of the server of FIG. 1,

FIG. 3 is a block diagram of the keyword filter of FIG. 2,

FIG. 4 is a schematic illustration of a data structure received by the server of FIG. 1,

FIG. 5 is a partial block diagram of the client of FIG. 1,

FIGS. 6 to 8 are screen shots of the display of the client of FIG. 1 during operation of the client in accordance with this invention,

FIGS. 9A, 9B, and 9C are flow diagrams illustrating the operation of the client of FIG. 1 in accordance with this invention, and

FIGS. 10A, 10B, and 10C are flow diagrams illustrating the operation of the server of FIG. 1 in accordance with this invention.

### DETAILED DESCRIPTION

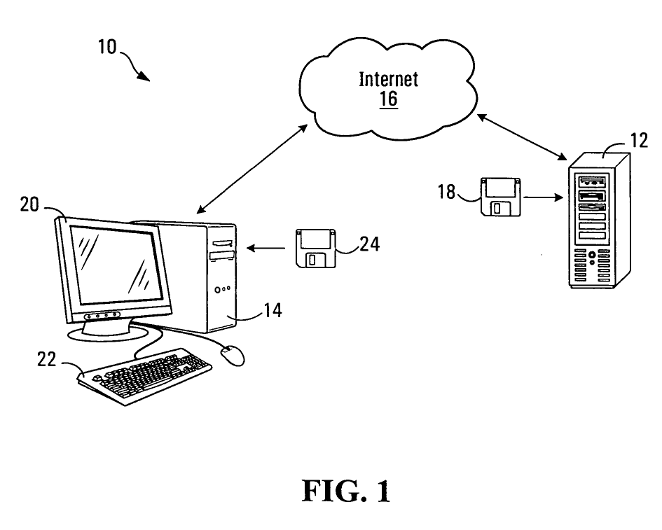

Turning to FIG. 1, a system 10 which employs the subject invention comprises a server 12 and a client computer 14 connected for two-way communication with the Internet 16. The server may comprise any suitable commercially available server which is adapted to operate in accordance with the teachings of this invention through a software load from computer readable media 18. Client computer 14 may be any suitable commercially available PC with a display 20 and a user interface 22. The interface is shown as a keyboard but may equally be any other suitable interface, such as a mouse or touch screen. The client 14 may have browser software, such as Microsoft Explorer™, for browsing the world-wide web available over the Internet 16. The client may be adapted to operate in accordance with the teachings of this invention by a software load from computer readable media 24. Computer readable media 18 and 24 may be any suitable computer readable media such as a disk, a read only memory, or a file downloaded from a remote source.

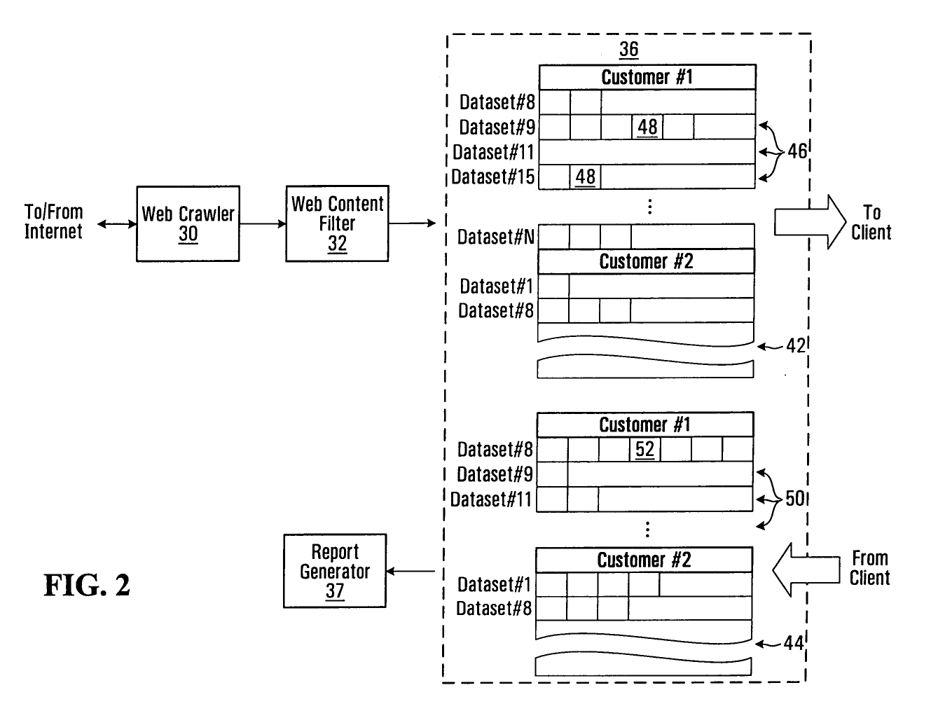

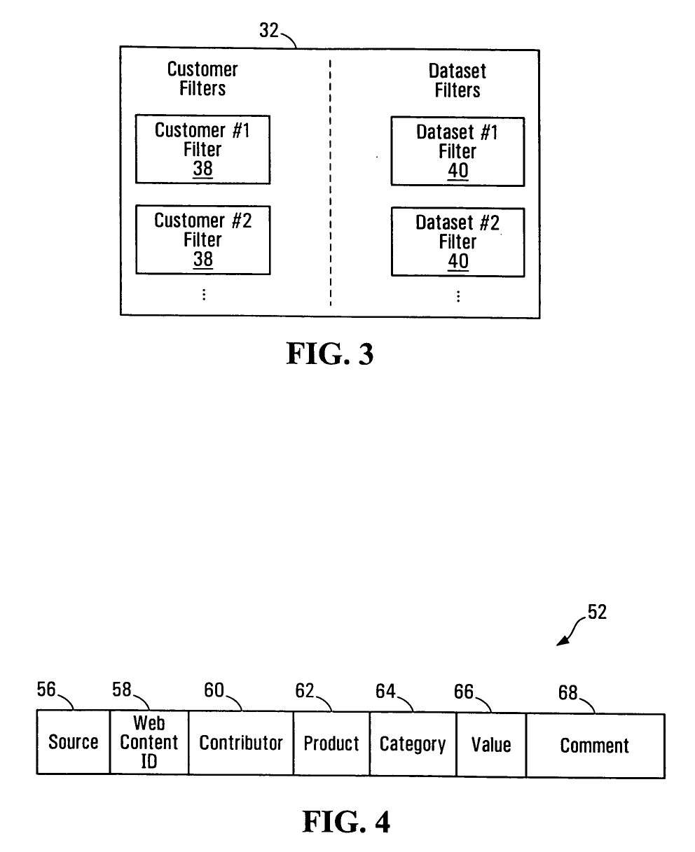

With reference to FIG. 2, the processor and memory of the server provide a web crawler 30, a web content filter 32, a database 36, and a report generator 37. The web crawler 30 may be any known web crawler which “crawls” the web, retrieving web content. The web crawler outputs to web content filter 32. With reference to FIG. 3, the web content filter 32 may comprise customer filters 38 and “dataset” filters 40. Each filter may comprise a set of keywords used to filter specific web content in order to identify any keywords in the set which appear in the specific web content. Returning to FIG. 2, the web content filter 32 outputs to database 36 which comprises a filtered web content database 42 and a categorisation record database 44. The filtered web content database 42 may have a series of queues 46 so as to provide one queue for each “dataset” of interest to a given customer. Each element 48 in a queue 46 may represent specific web content (typically by providing a pointer to specific web content stored elsewhere in the memory of the server). The categorisation record database 44 may have a series of queues 50, again to provide one queue for each “dataset” of interest to each customer. Each element 52 in a queue 50 may represent one categorisation record. Turning to FIG. 4, a categorisation record may comprise a source field 56, a web content identifier field 58, a contributor field 60, a product field 62, a category field 64, a value field 66, and a comment field 68. The database 36 outputs to a report generator block 37 which prepares summaries of enqueued categorisation records.

In initial operation of server 12, based on inputs from an administrator, suitable dataset filters 40 and customer filters 38 are built and, thereafter, selected dataset filters 40 may be associated with selected customer filters 38 in order to configure web content filter 32. With web content filter 32 configured, web content available over the Internet which is returned by web crawler 30 is applied to the selected customer filters and associated dataset filters. Content which passes through these filters is enqueued on an appropriate one of queues 46 of filtered web content database 42.

A customer filter may comprise a set of keywords which are known to be indicative of a particular entity. For example, if the entity were the corporation XYZ, Limited and it was often known in the marketplace by its trading style “BREEZY”, a customer filter for XYZ Limited may consist of the keywords “XYZ” and “BREEZY”. In consequence, retrieved web content (e.g., a web page) would pass through the XYZ Limited filter if it were found to contain one or more instances of either “XYZ” or “BREEZY”. If the web content passed through the XYZ Limited filter, it would then be applied separately to each of the dataset filters 40 associated with the XYZ Limited filter. A given dataset filter might contain a set of keywords to represent a product sold by an entity, or an attribute of products sold by an entity. For example, if XYZ Limited sold automobiles, a dataset filter might contain a set of keywords related to powertrains, such as the words “powertrain”, “transmission”, “drive train”, “drive linkage”, etc. An item of web content that passed through this “powertrain” filter would then be queued on the queue 46 designated for the powertrain dataset of XYZ Limited. This process continues, adding to the queues of filtered web content database 42.

Optionally, the keywords identified by the customer filter and the associated dataset filter may be tagged in the web content that is enqueued so that the keywords will be highlighted when displayed. As a alternative option, an array may be formed of these keywords, which array is stored with the enqueued web content.

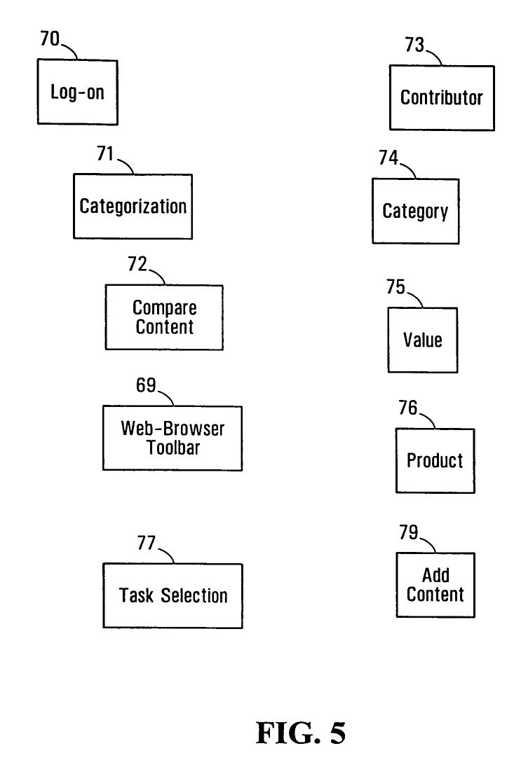

Turning to the client side, FIG. 5 schematically illustrates the memory of client 14 after receiving software load from media 24. The memory may hold a web-browser toolbar object 69 to modify the toolbar of the web browser of client 14, a log-on object 70 to enable logging on to the server 12, a categorisation object 71 to enable creation of categorisation records, a compare content object 72 to enable addition of new web content to database 36, and a task selection object 77 to allow a user to select a desired task. Additionally, the memory may hold a contributor object 73, a category object 74, a value object 75 and a product object 76, each of which may hold lists of information. Objects 73 to 76 may be populated with information from the software load from media 24, or one or more of these objects may be dynamically populated by server 12.

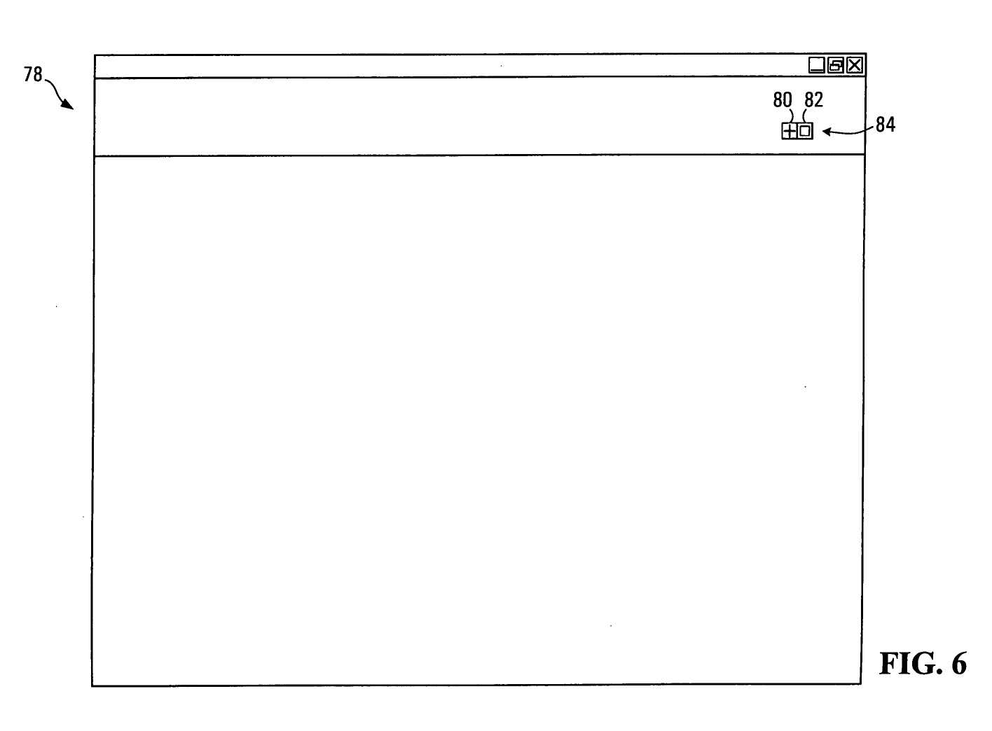

When the web browser application of the client is running, as illustrated in FIG. 6, the web-browser toolbar object 69 adds two buttons 80, 82 to the toolbar 84 of the web browser screen 78. Button 82 may be selected to initiate a log-on session with server 12 and button 80 may be selected to request addition of web content to database 36 (FIG. 2) of server 12.

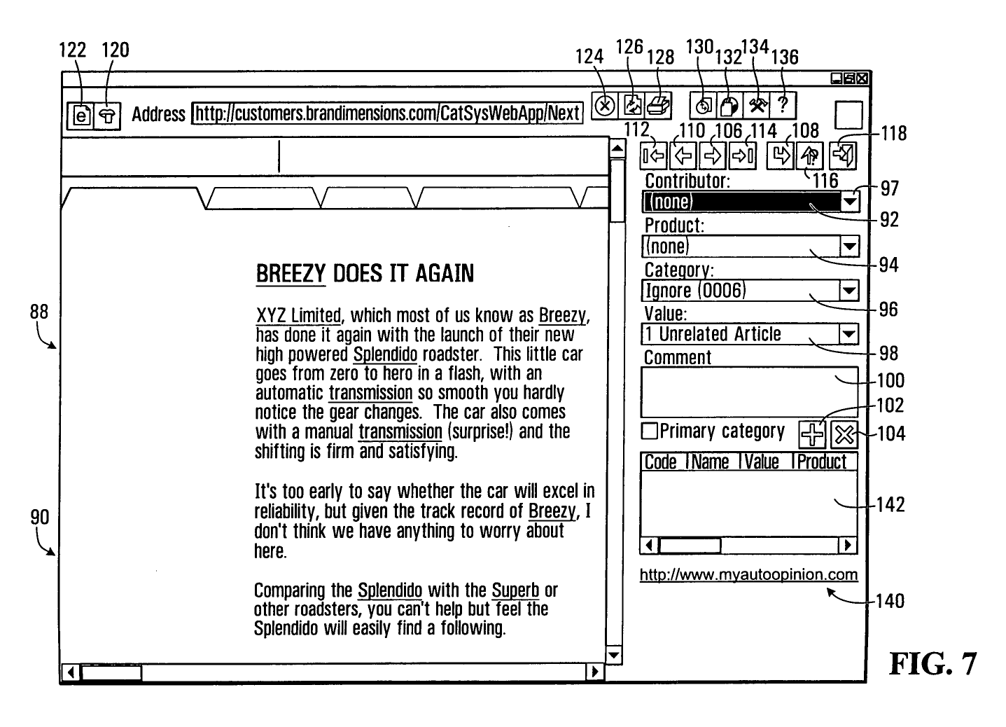

With the categorisation object 71 running in the foreground, the screen of display 20 of the client may appear as illustrated in FIG. 7. The screen 88 may have a window 90 for the display of web content and, as well, a series of windows each of which is a single line, that is, a “contributor” line 92, a “product” line 94, a “category” line 96, and a “value” line 98. The “contributor” object 73, “category” object 74, “value” object 75 and “product” object 76 may be called by a user selecting a down arrow 97 that may be associated with each line in order to provide a drop down menu of informational items. Screen 88 may also provide a “comment” box 100 and a number of additional buttons as follows:
an “add” button 102 to log a categorisation record;
a “delete” button 104 to remove a selected logged categorisation record;
a “completion” button 106 to forward logged categorisation records to the server and receive the next item of web content from the same queue of the server;
a “skip” button 108 to delete logged categorisation records and skip to the next item of web content from the same queue of the server;
a “back” button 110 to return to the previous item of web content;
a “back-to-skipped” button 112 that returns to the last item of web content that was left uncategorized;
a “forward-to-skipped” button 114 that skips forward to the next item of web content that was left uncategorized;
a “query” button 116 to allow the sending of a question to a supervisor;
a “log-out” button 118 to allow logging off the server;
a “source code” button 120 and “display layout” button 122 to allow toggling between the display of source code for a display layout and the display layout itself;
a “stop” button 124 to stop loading of the web content;
a “refresh” button 126 to allow the current web content to be refreshed from the server;
a “print” button 128 to allow the currently displayed web content to be printed;
a “session history” button 130 to allow the user to obtain information on work done thus far in the current categorisation session;
a “web location” button 132 to open a new browser window to allow viewing of the web content at its actual web location;
a “preferences” button 134 allowing certain user adjustments to the screen display; and
a “help” button 136 to open a reference guide.

The screen 88 may also include certain information panels, such as a panel 140 which indicates the location (typically, the universal resource locator (URL)) for the web content and a window 142 which displays logged categorisation records.

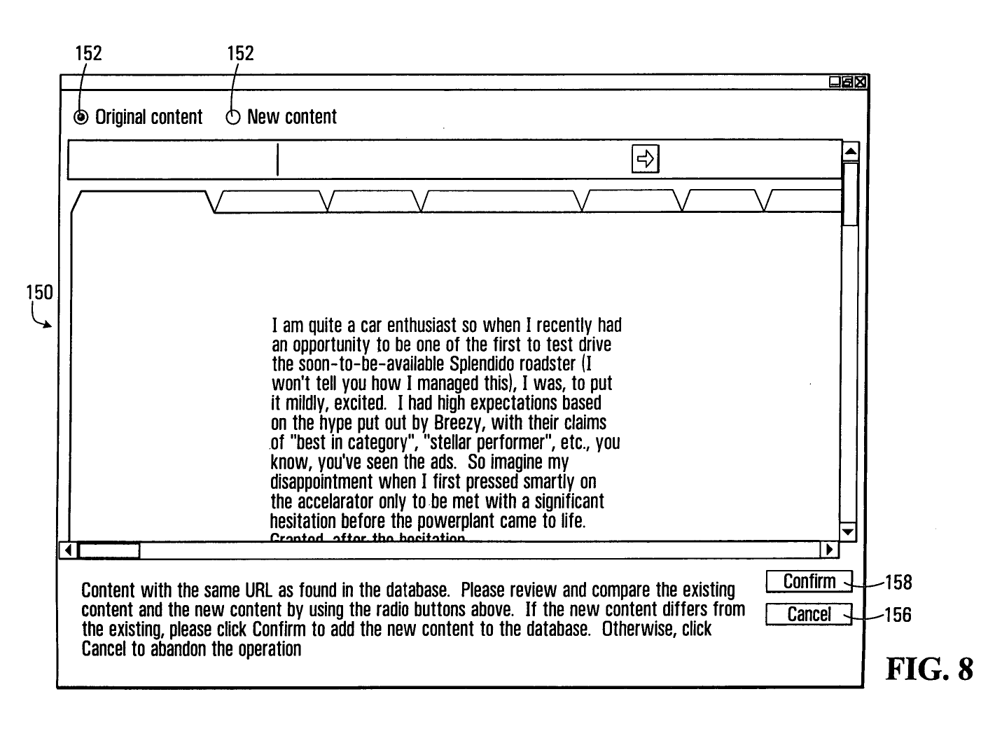

With the compare content object 72 running in the foreground, the screen of display 20 of the client may appear as illustrated in FIG. 8. Screen 150 has radio buttons 152, 154 to switch between “original” content and “new” content in order to allow comparison between the two. A “cancel” button 156 is provided to return to screen 88 of FIG. 7. A “confirm” button 158 is used to add “new” content to database 36 of server 12 and then return to screen 88 of FIG. 7 with the “new” web content displayed in window 90.

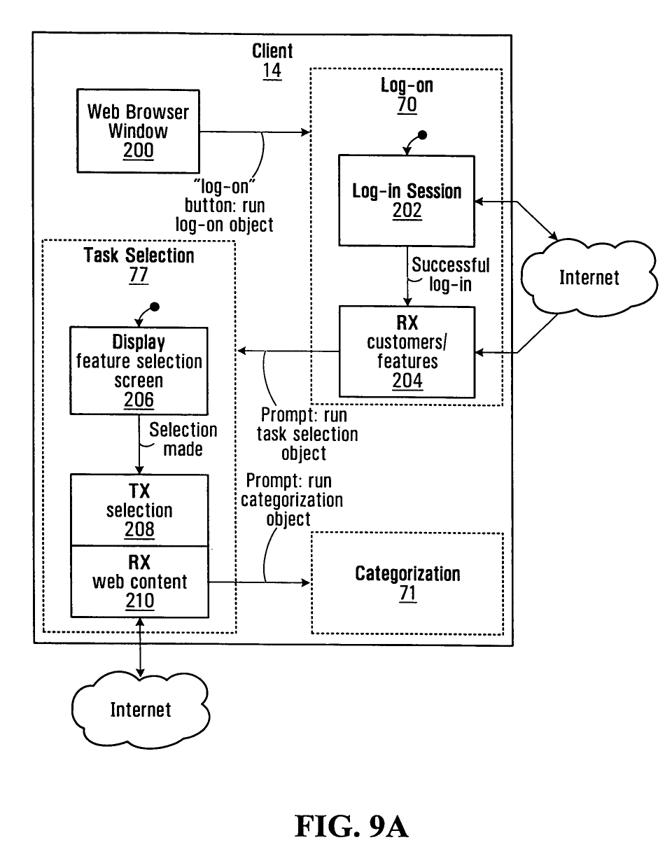

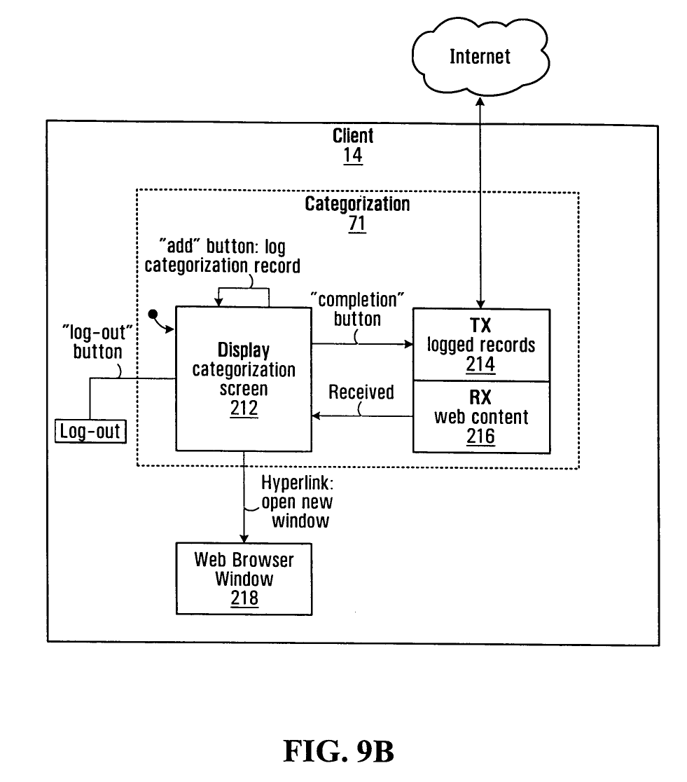

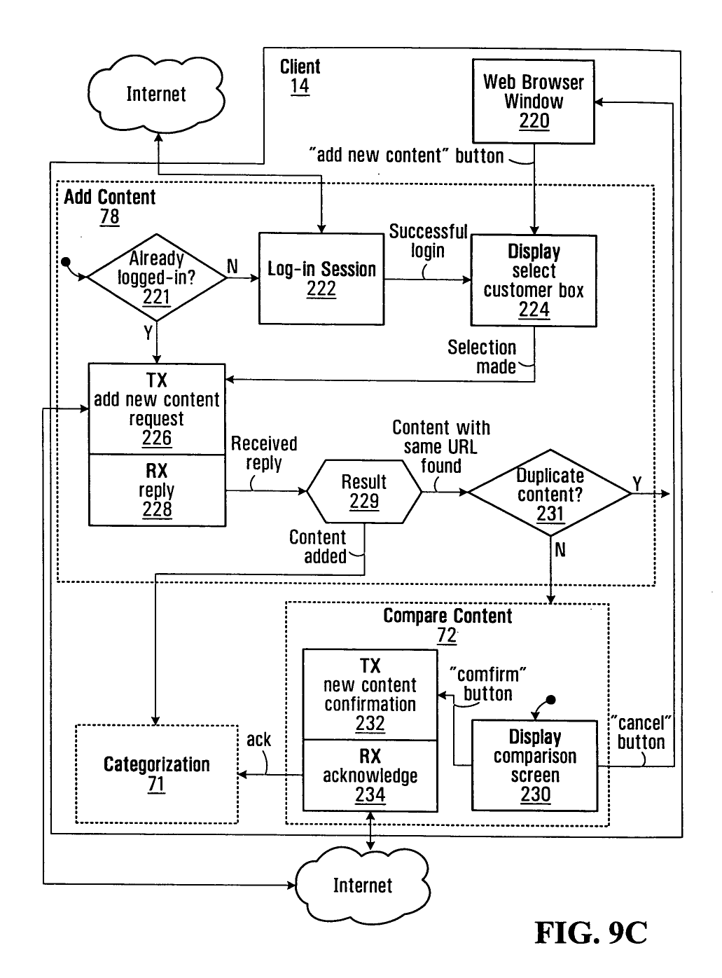

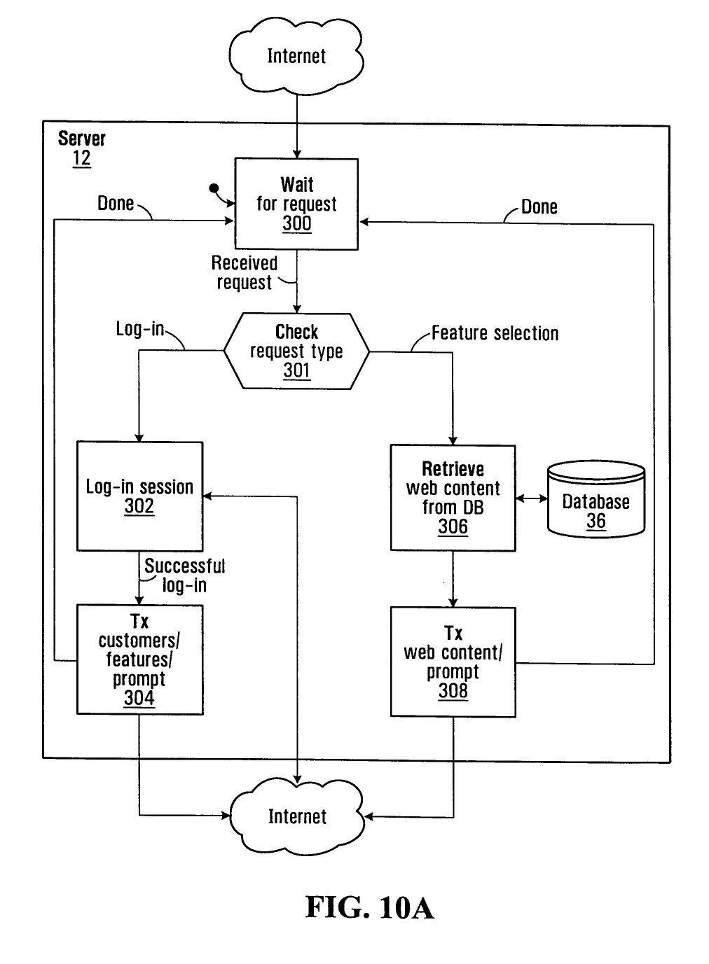

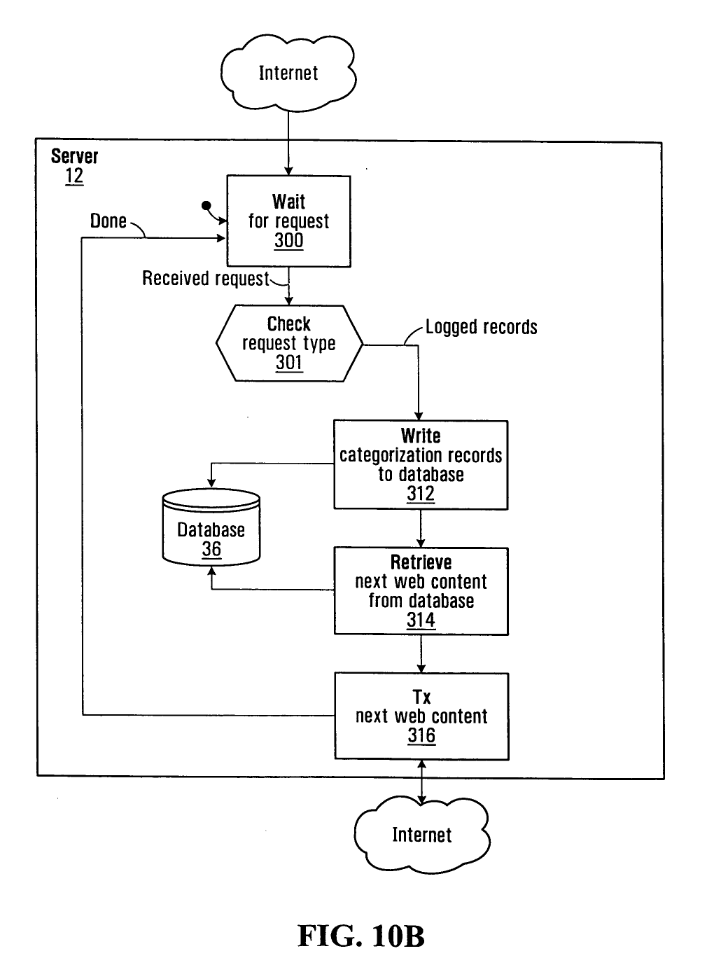

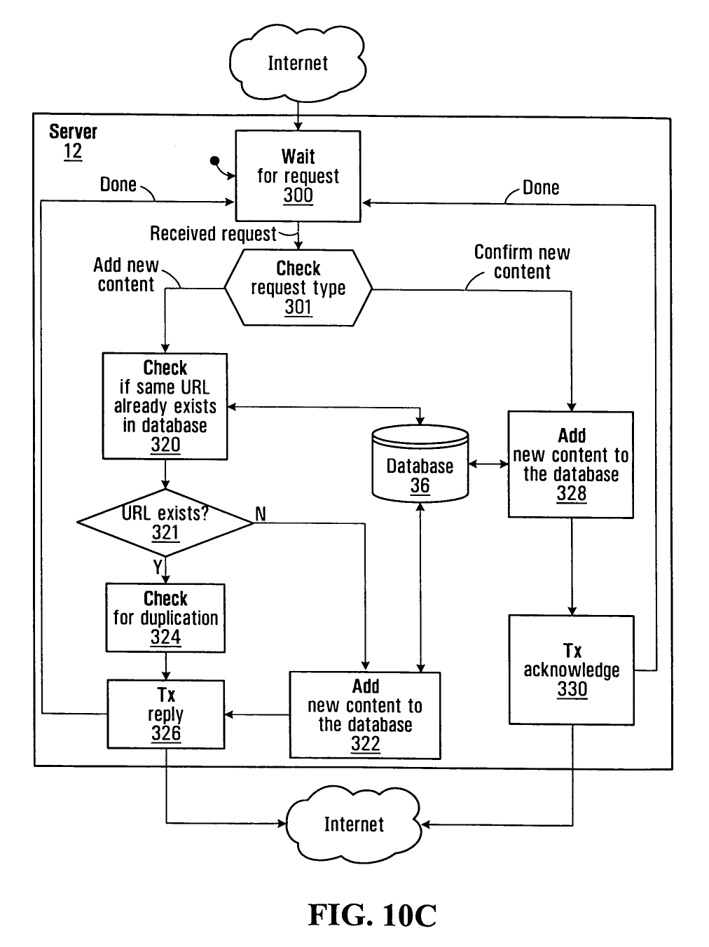

Referring to FIGS. 9A, 9B, and 9C, which comprise a flow diagram illustrating operation of the processor of the client 14 under control of software from media 24 and FIGS. 10A, 10B, and 10C, which comprise a flow diagram illustrating operation of the processor of server 12 under control of software from media 18, the system operates as follows. A user, running the web browser application may be viewing screen 78 of FIG. 6 (200: FIG. 9A). By selecting button 82, log-on object 70 runs to initiate a log-on session with server 12 (202: FIG. 9A; 302: FIG. 10A). After successful log-in, based on permissions associated with the particular user at server 12, the server sends the client 14 an indication of one or more customers and the datasets associated with each customer along with a prompt to run task selection object 77 (204: FIG. 9A; 304: FIG. 10A). The task selection object 77 presents a screen with information allowing the user to select a dataset associated with a customer and send an indication of the selected dataset and associated customer to the server 12 (206, 208: FIG. 9A). The server uses this returned information as a key into database 36 (306: FIG. 10A). More specifically, the customer and dataset information is used by the server to select a queue 46 in filtered web content database 42. The web content of the element 48 at the head of the selected queue is then sent to the client along with a prompt so that the client runs categorisation object 71 (210: FIG. 9A; 308: FIG. 10A). In one embodiment, along with the web content, the server may also send content for product object 76. The server may then move a pointer so that the next element 48 in the queue is indicated to be the head of the queue.

With categorisation object 71 running, the screen may appear as screen 88 of FIG. 7 (212: FIG. 9B). Window 90 of screen 88 is populated with the web content received from the server. This web content may have keywords that were tagged at the server highlighted (or a set of these keywords may be sent from the server and used by the client to find and highlight these keywords). The user may review the displayed web content for understanding of what the content states relative to the customer that the user had selected. For example, assuming again that the selected customer and dataset is “XYZ Limited” and “powertrain”, the user may note a relevant textual passage in the web content and, based on this, create a categorisation record, as follows. A contributor for the textual passage is entered into “contributor” line 92. The choices for the contributor may be chosen from a drop-down menu which may include the categories of: “none”; “competitor”; “consumer”; “industry professional”; “journalist”; and “media”. A product that is the subject of the textual passage may then be entered into the “product” line 94. The choices for the product may also be chosen from a drop-down menu (created from information received the server or, possibly, created by the software load from computer readable media 24). If the customer is an automotive company, the menu of products may be a list of different automobiles. Next, a category may be chosen for the selected product. The category may be an indication of the dataset (e.g., “powertrain”) that the user had selected in selecting a customer and associated dataset. However, the textual passage could also concern a different category. The category may be a physical property of the product (such as “fuel economy” or “acceleration”), or a visceral feature (such as comfort, appeal, or image). The category may be restricted to one of a drop-down list of choices; each category may be defined by words and by a number so that a user may select a category by number or words. After selection of the category, the user may assign a value which was attributed to the category by the textual passage. These values may chosen from the list of “poor”, “mediocre”, “average”, “good”, “great”, and “unrelated article”. The textual passage itself may then be copied and pasted into the “comment” window 100. This completes the information needed for the categorisation. If the user is satisfied with the information, the user may then select the “add” button 102 to log the information as a categorisation record. The logged record then appears in window 142.

The user may repeat this process, finding other textual passages from which categorisation records may be created. In this regard, the highlighting of keywords in the web content may assist the user in more quickly identifying relevant textual passages. To further facilitate this, keywords having different properties may be highlighted differently. For example, keywords which are nouns may be highlighted by one colour and those that are adjectives may be highlighted by a different colour.

Once the user has completed creating categorisation records for the web content, the user may click the “completion” button 106 to forward logged categorisation records (in the format illustrated in FIG. 4) to server 12 (214: FIG. 9B). When server 12 receives logged categorisation records from client 14, it writes the categorisation records to database 36, retrieves the next item of web content from database 36, and sends this web content to client 14. More specifically, server 12 writes each categorisation record received from client 14 to the appropriate queue 50 (based on the selected customer and dataset) in categorisation record database 44 (312: FIG. 10B). Server 12 then retrieves the next item of web content from the appropriate queue 46 (based on the selected customer and dataset) in filtered web content database 42 (314: FIG. 10B) and sends it to client 14 (316: FIG. 10B). The server may then adjust a pointer so that the next element 48 in queue 46 is indicated to be the head of the queue.

When client 14 receives the next item of web content, window 90 of screen 88 is populated with the web content received from server 12 (216, 212: FIG. 9B). In addition, categorisation log window 142 is cleared so that the screen is prepared for the user to create categorisation records from the new web content.

Web content may contain hyperlinks which link to other web content. The hyperlinks of web content within window 90 may be enabled so that if the user selects a hyperlink within window 90, a new web browser window may open and be directed to the linked web content (212, 218: FIG. 9B). The screen display will then be as indicated at 78 in FIG. 6.

While browsing web content on the Internet—through linking to such content while categorizing other web content, or simply while “surfing” the Internet—the user may come across content that may be found to be relevant to customers for whom the user performs categorisation. The user can add this content to the categorisation system by selecting “add-content” button 80 (FIG. 6), which causes add content object 78 to run (220: FIG. 9C).

If the user is not already logged-in to the system, add content object 78 initiates a log-in session in order to establish a connection over the Internet with server 12 (221, 222: FIG. 9C). Once logged-in, add content object 78 displays a dialog box allowing the user to select the customer for whom the content is being added (224: FIG. 9C). When the selection is made, add content object 78 sends a request to server 12 to add the new content for the selected customer to the system (226: FIG. 9C). If the user is already logged on, selecting “add-content” button 80 immediately results in sending a request to server 12 to add the new content (221, 226: FIG. 9C).

When server 12 receives a request to add new web content from client 14, it checks database 36 for the existence of content with the same URL (320: FIG. 10C). If content with the same URL does not exist in database 36, server 12 adds the new web content to database 36 and sends a response to client 14 containing the new web content and an indication that the content was added to the system (321, 322, 326: FIG. 10C). If, on the other hand, web content with the same URL is already present in database 36, server 12 checks for duplication by comparing the new content received from client 14 against the content in database 36 (321, 324: FIG. 10C). If the new content received from client 14 does not match the content found in database 36, server 12 transmits a response to client 14 containing both the new web content and the pre-existing web content along with a prompt to run compare content object 72 (326: FIG. 10C). If, however, the new content received from client 13 matches the content found in database 36, server 12 sends a response to client 14 indicating that duplicate web content already exists in the system (326: FIG. 10C).

When client 14 receives a response from server 12 indicating that the new web content was added to the system, categorisation object 71 is initialized and window 90 of categorisation screen 88 is populated with the new web content so that it may be categorized (228, 229, 71: FIG. 9C; 212: FIG. 9B).

When client 14 receives a response from server 12 indicating that duplicate content with the same URL already exists in the system, a dialog box informs the user that the content already exists in the system, and the user returns to the web browser window (228, 229, 231, 220: FIG. 9C)

When client 14 receives a response from server 12 indicating that non-duplicate content with the same URL already exists in the system, client 14 is prompted to run compare content object 72 (228, 229, 231, 72: FIG. 9C). When initialized, compare content object 72 displays comparison screen 150 of FIG. 8 (230: FIG. 9C). A dialog informs the user that the URL requested to be added exists in the system but the content in the system does not exactly match the content requested to be added. The user is asked to compare the “original” content found in the system and the “new” content requested to be added to decide whether the two are the same. If the user determines that the “new” content is different than the “original” content, the user may select a button (not shown) to send a confirmation to server 12 that the new web content is to be added to database 36 (232: FIG. 9C). Upon receiving this confirmation, server 12 adds the new content to database 36 and transmits an acknowledgement to client 14 (328, 330: FIG. 10C). When client 14 receives the acknowledgement, it initializes categorisation object 71 and window 90 of categorisation screen 88 is populated with the new web content so that it may be categorized (234, 71: FIG. 9C; 212: FIG. 9B).

By way of example, the web content may be a web page, a blog, or a chat room archive.

A number of different users at different clients may feed categorisation records to server 12. Once all of (or a sufficient portion of) the queued web content for a customer has been categorized, the server may cease offering users the option of categorizing for that customer and may generate reports from the queued categorisation records using report generator object 37. For example, these reports may contain averages of the value of each category found in the categorisation records with an indication of the number of records containing this category. The reports may also include some of the comments received for each category.

In summarizing categorisation records, records where the contributor field 60 (FIG. 4) indicates that the contributor is a competitor may be ignored, as may records where the category field 64 for the record is set to “ignore”.

Optionally, when a client sends a request to add linked web content to database 36, server 12 could automatically compare such linked web content with any older version of the linked content and add the new content to database 36 if the linked web content had additional information that was likely to impact the exercise of categorisation. This could be determined by filtering the new content with web content filter 32. Further, if the old content had not yet been categorized, the database 36 at server 12 could simply be updated to replace the old content with the linked content. On the other hand, if the old content had already been categorized, the server could only send the new portion of the linked content to the client 14 for categorisation.

The filtered web content may be stripped of images before being enqueued to reduce memory requirements. As another option, rather than queuing web content, the universal resource locators (URLs) to the web content may be queued. In such instance, the server simply sends a URL to the client directing the client's browser to retrieve the web content and place it in window 90 of screen 88 (FIG. 7). As well, the server may send a set of keywords with the URL so that the keywords are highlighted. A drawback with this optional operation is that if the server does not store the actual web content, the server could not compare categorized web content with web content proposed by a user for entry in the database.

While the web content filter has been described as simply comprising keyword filters, it will be appreciated that a more sophisticated filtering approach could be employed. For example, in addition to simple keyword filtering, filtering may also be based on the frequency of keywords in a document, the spacing between keywords in a document (i.e., the number of characters between two keywords), stems of keywords, etc. Furthermore, server 12 could utilise information in the returned categorisation records to improve future web content filtering. For example, if a categorisation record indicated that the categorised web content should be ignored, the server could add the URL for the web content to a list of URLs that, with respect to the particular customer, point to web content that is not to be enqueued when enqueuing updated web content for that customer. Each URL in the list could be time stamped such that a URL would fall off the list after a per-set period of time (and would then be a candidate for reintroduction to the list dependent upon the feedback from future categorisation records).

At least the fields “product” and “value” in the categorisation record 52 of FIG. 4, and the corresponding lines 94, 98 in the screen display of FIG. 7, could be replaced by other fields, and corresponding lines, in order to allow creation of categorisation records adapted to different customer needs. For example, a customer may be concerned with items other than products, such as services or, if the customer were a political party, with politicians names. In such case, the product field in the categorisation record of FIG. 4 could be replaced by a service field or a name field, as appropriate. The corresponding lines in the screen display would be similarly renamed. Additionally, the product object 76 of FIG. 5 would then become a service object or a name object storing a suitable list that could be displayed, on command, in a drop down menu on the screen display of FIG. 5.

The word “server” as used herein should be taken to encompass not only a single physical server but also a set of servers that perform the functions of exemplary server 12 (FIG. 1). With a set of servers, one of the servers could, for example, provide internet content, and another of the servers could receive categorisation records. Similarly, exemplary database 36 (FIG. 2) should be taken as encompassing not only a single database but also a distributed database.

What is claimed is:

1. A computer readable medium containing computer readable instructions which, when executed by a client computer, adapt said client computer to:
obtain a set of categorisation selections;
receive internet content from a server;
display said internet content on a display of said client;
receive from a user interface a categorisation selection from said set of categorisation selections; and
send said categorisation selection to said server.

2. The computer readable medium of claim 1 further adapting said client computer to:
display said internet content in a first window of said display; and
display said categorisation selection in a second window of said display.

3. The computer readable medium of claim 1 further adapting said client computer to:
responsive to a user prompt, display at least a portion of said set of categorisation selections on said display.

4. The computer readable medium of claim 1 wherein said internet content is web content.

5. The computer readable medium of claim 4 wherein said web content is received with an indication resulting in keywords of said web content being highlighted.

6. The computer readable medium of claim 4 wherein said web content is first web content and further adapting said client computer to link to a linked web page addressed by a hyperlink of said first web content on receiving a user prompt through said user interface.

7. The computer readable medium of claim 6 further adapting said client computer to:
receive from said user interface a request to categorize said linked web content; and
send an indication of said linked web content to said server.

8. The computer readable medium of claim 7 further adapting said client computer to:
receive a categorisation selection for said linked web content from said set of categorisation selections; and
send said categorisation selection to said server.

9. The computer readable medium of claim 7 further adapting said client computer to:
receive an indication from said server refusing said linked web content.

10. The computer readable medium of claim 4 wherein said web content has source code defining a display layout and further adapting said client computer to:
provide a user interface allowing switching between display of said web content according to said display layout and said source code for said web content.

11. The computer readable medium of claim 2 further adapting said client computer to:
obtain a set of item selections;
receive from said user interface an item selection from said set of item selections;
send said item selection to said server along with said categorisation selection.

12. The computer readable medium of claim 11 further adapting said client computer to:
display said item selection in a third window of said display;
and send said item selection to said server along with said categorisation selection responsive to a user prompt.

13. The computer readable medium of claim 12 further adapting said client computer to:
display a fourth window permitting entry of text; and
wherein, when sending said item selection to said server along with said categorisation selection, further sending any text entered to said fourth window.

14. The computer readable medium of 13 wherein said item selection, said categorisation selection and said entered text are sent to said server as a record along with an identifier of said web content.

15. The computer readable medium of claim 13 further adapting said client computer to:
send a completion indication to said server and receive from said server further web content for display in said first window.

16. The computer readable medium of claim 5 wherein a first plurality of said keywords are highlighted in a manner visually distinct from a second plurality of said keywords.

17. At a client, a method of processing internet content, comprising:
receiving a set of categorisation selections;
receiving internet content from a server;
displaying said internet content on a display of said client;
receiving from a user interface a categorisation selection from said set of categorisation selections;
sending said categorisation selection to said server.

18. At a server, a method of categorizing web content, comprising:
filtering web content;
responsive to said filtering, adding a given item of web content to a database;
sending said given item of web content to a client;
receiving from said client an indication of a categorisation for said given item of web content;
logging said categorisation;
marking said given item of web content as categorized.

19. The method of claim 18 wherein said filtering comprises searching web content for keywords.

20. The method of claim 18 further comprising:
based on said receiving, further filtering web content.

21. The method of claim 19 wherein said further filtering comprises listing sources of web content that is not to be added to said database.
